(19) United States
(12) Patent Application Publication
(10) Pub. No.: US 2026/0117916 A1
(43) Pub. Date: Apr. 30, 2026

(54) SWITCHABLE MAGNETIC DEVICE HOLDER

(71) Applicant: The Board of Trustees of The University of Alabama, Tuscaloosa, AL (US)

(72) Inventors: Ian Y. Shen, Tuscaloosa, AL (US); Greg Berkeley, Tuscaloosa, AL (US)

(21) Appl. No.: 19/375,370

(22) Filed: Oct. 31, 2025

Related U.S. Application Data
(60) Provisional application No. 63/714,566, filed on Oct. 31, 2024.

(51) Int. Cl. F16M 11/04; F16M 11/22; B60R 11/00; B60R 11/02

(52) U.S. Cl. CPC F16M 11/041; F16M 11/22; B60R 2011/0003; B60R 2011/007; B60R 11/0241

(57) ABSTRACT

A device mount configured to selectively secure a device thereto. The device mount includes a housing defining an attachment portion, and an electropermanent magnet supported within the attachment portion. The electropermanent magnet is configured to emit a magnetic field that secures the device to the device mount. The device mount further includes a switch coupled to the housing and in communication with the electropermanent magnet. The switch is configured to selectively adjust the magnetic field of the electropermanent magnet to release the device from the device mount.

### CROSS REFERENCE

This application claims the priority benefit of U.S. Provisional Patent Application No. 63/714,566 filed October 31, 2024, which is hereby incorporated herein by reference in its entirety.

### GOVERNMENT LICENSES RIGHTS

This invention was made with government support under grant number 2234621 awarded by the National Science Foundation. The government has certain rights in the invention.

### BACKGROUND

Existing systems for attaching devices can be largely divided into two types. The first type is mechanical attachment, which involves a bracket that holds a device through mechanical constraints. Mechanical attachment type mounts are usually simple and provide reliable holding force, but require precise positioning and careful manipulation in the attaching and detaching process. The other type is magnetic attachment, which uses magnets to provide magnetic force for holding a portable device. Without the need for precise positioning, magnetic device holders are becoming more popular, exemplified by the Apple MagSafe^{TM} technology. To provide reliable attachment, strong magnets are often used to provide a sufficiently large magnetic holding force. However, the strong magnetic force also makes it difficult to detach devices from the holder. Most likely, two hands are needed to remove a device from a magnetic holder, which can be a very inconvenient process for everyday use. Removal of the device may also disturb the position of the device mount.

### SUMMARY

Various implementations described herein are related to a magnetic device mount. In some aspects, the magnetic device mount may be configured for selectively mounting mobile electronic devices (e.g., smart phones, tablets, or the like) and/or small tools or instruments (e.g., remote controller, tools, measuring instruments, or the like) relative to a surface. For example, the device mount may be used in a vehicle (e.g., car, motorcycle, etc.), on an assistive device (e.g., walker, rollator, shopping cart, etc.), or on a desktop mount. The convenience and reliability of removing the device during an activity may impact the completion of many important existing or future tasks (e.g., navigating busy city streets in a car and guiding memory-impaired older adults in community walking).

Various implementations relate to a magnetic device mount configured to selectively secure a device thereto. The device mount includes a housing defining an attachment portion and an electropermanent magnet supported within the attachment portion. The electropermanent magnet is configured to emit a magnetic field that secures the device to the device mount. The device mount further includes a switch coupled to the housing and in communication with the electropermanent magnet. The switch is configured to selectively adjust the magnetic field of the electropermanent magnet to release the device from the device mount.

In some aspects, the device mount further includes a controller in communication with the switch and the electropermanent magnet, and activation of the switch is configured to adjust a current provided to the electropermanent magnet to deactivate the magnetic field and release the device from the device mount.

In some aspects, the switch includes a touch sensor and a signal processing circuit, and the touch sensor is configured to be activated in response to detection of a presence of an operator's finger.

In some aspects, the touch sensor is configured to be activated when the presence of an operator's finger is detected for a predetermined amount of time, and the current to the electropermanent is adjusted for a predetermined duration to release the device from the device mount.

In some aspects, the attachment portion includes a front surface, a rear surface opposite the front surface, and a side surface extending between the front surface and the rear surface, wherein the electropermanent magnet is supported within the front surface, and the touch sensor is supported within the side surface.

In some aspects, the touch sensor is a first touch sensor, and a second touch sensor is supported within the side surface at a position that is opposite and spaced apart from the first touch sensor.

In some aspects, the switch is an electromechanical switch.

In some aspects, the device mount further includes an accelerometer in communication with the controller, and the controller is configured to increase the magnetic field when the accelerometer detects excessive acceleration on the device mount.

In some aspects, the electropermanent magnet is one of a plurality of electropermanent magnets.

In some aspects, the device mount further includes a permanent magnet, and the permanent magnet is positioned between two of the plurality of electropermanent magnets.

In some aspects, the housing includes a support arm extending from the attachment portion.

In some aspects, the housing includes a base coupled to the support arm, wherein the base is configured to support the device mount on a surface.

In some aspects, the device mount includes a securing mechanism coupled to the attachment portion, wherein the securing mechanism is configured to couple the device mount to a surface or structure.

Various implementations described herein relate to a device mount configured to selectively secure a device thereto. The device mount includes a housing defining an attachment portion and an electropermanent magnet supported within the attachment portion. The electropermanent magnet configured to emit a magnetic field that secures the device to the device mount. The device mount also includes a controller in communication with the electropermanent magnet. The controller is configured to adjust a current provided to the electropermanent magnet to selectively adjust the magnetic field and release the device from the device mount in response to a user input.

In some aspects, the device mount further includes a switch coupled to the housing and in communication with the electropermanent magnet and the controller. In some aspects, the controller is configured to selectively adjust the magnetic field of the electropermanent magnet to release the device from the device mount in response to actuation of the switch. In some aspects, actuation of the switch defines the user input.

In some aspects, the device mount further includes a permanent magnet and the electropermanent magnet is one of a plurality of electropermanent magnets. In some aspects, the permanent magnet is positioned between two of the plurality of electropermanent magnets.

In some aspects, the device mount further includes an accelerometer in communication with the controller. In some aspects, the controller is configured to increase the magnetic field when the accelerometer detects excessive acceleration on the device mount.

Various implementations described herein relate to a method of coupling a device to a transportation or assistance device during operation of the transportation or assistance device, the method including: providing a device mount having an attachment portion that supports an electropermanent magnet configured to emit a magnetic field that secures the device to the device mount, the device mount having a switch in communication with the electropermanent magnet and a controller in communication with the switch; providing an operation signal to the controller related to operation of the transportation or assistance device; permitting actuation of the switch to deactivate the magnetic field when the transportation or assistance device is not in operation to allow the device to be removed from the device mount; and preventing actuation of the switch to restrict deactivation of the magnetic field of the electropermanent magnet when the controller receives the operation signal.

In some aspects, the method further includes determining the operation signal with an operation sensor supported in the device mount.

In some aspects, the method further includes determining the operation signal by receiving a signal from a control system of the transportation or assistance device.

In some aspects, permitting actuation of the switch occurs when the operation signal is not received by the controller.

In some aspects, permitting actuation of the switch occurs when a non-operation signal is received by the controller.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

Various implementations of devices, systems, and methods are explained in even greater detail in the following drawings. The drawings are merely exemplary and certain features may be used singularly or in combination with other features. The drawings are not necessarily drawn to scale.

FIG. 1 is a right perspective view of a device mount.

FIG. 2 is a perspective view of the device mount of FIG. 1 with a mobile electronic device coupled to the device mount.

FIG. 3 is a left perspective view of the device mount of FIG. 1.

FIG. 4 is a perspective view of a device mount according to another implementation of the disclosure.

FIG. 5 is a perspective view of a device mount according to another implementation of the disclosure.

FIG. 6 is a schematic view of the device mount of any of the implementations disclosed herein.

FIG. 7 is a flow chart of a control scheme for removing a device from the device mount of any of the implementations disclosed herein.

FIG. 8 is a schematic view illustrating a control system between the device mount of any of the implementations disclosed herein in communication and a smart transportation or assistance device.

FIG. 9 is a flow chart of a control scheme for the communication between the device mount of any of the implementations disclosed herein with the smart transportation or assistance device.

### DETAILED DESCRIPTION

Following below are more detailed descriptions of concepts related to, and implementations of, methods, apparatuses, and systems for a device mount. The figures illustrate exemplary implementations in detail and the present disclosure is not limited to the details or methodology set forth in the description or illustrated in the figures. The terminology used herein is for the purpose of description only and should not be regarded as limiting.

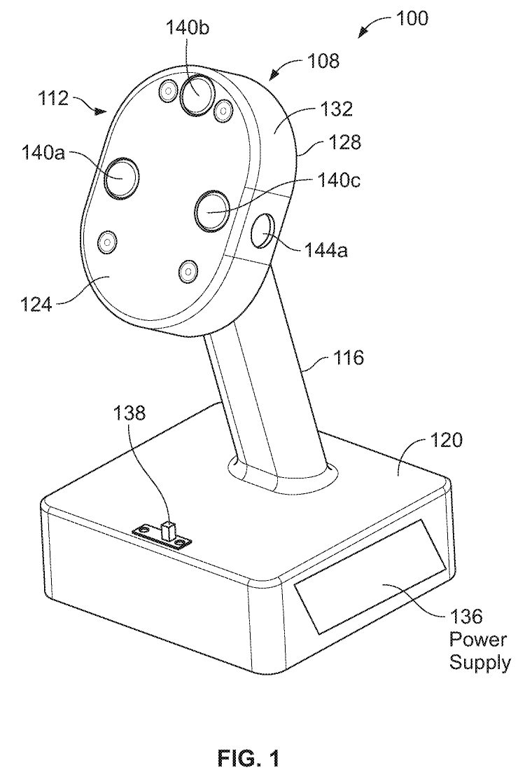

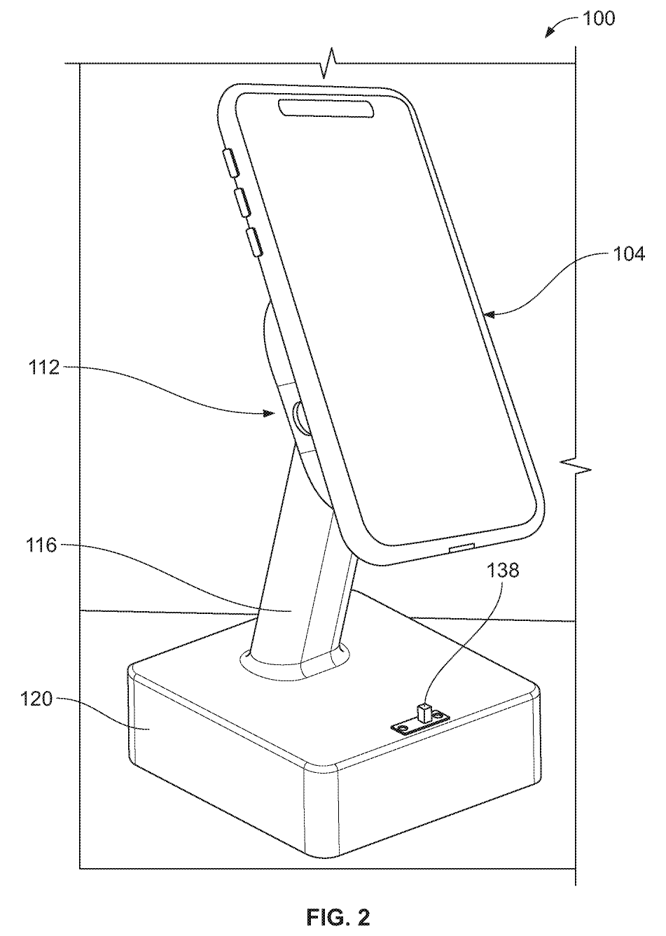

FIGS. 1-3 illustrate a device mount 100. In the implementation shown, a mobile electronic device 104 (FIG. 2) is shown for being selectively secured to the device mount 100. The mobile device 104 may be a smart phone, a tablet or the like. In other implementations, the device mount 100 may secure other devices such as remote controllers, tools, measuring instruments. Therefore, the term “device” may incorporate any of the mobile electronic devices, tools, or instruments described herein or equivalents thereof.

The device mount 100 includes a housing 108 defining an attachment portion 112, a support arm 116, and a base 120. The attachment portion 112 includes a front surface 124, a rear surface 128, and a side surface 132 extending between the front and rear surface 124, 128. The side surface 132 defines an outer perimeter of the attachment portion 112 that extends transversely (e.g., orthogonally) to the front surface 124. In other words, the side surface 132 defines a thickness of the attachment portion 112.

In some implementations, the device mount 100 further includes an attachment mechanism (not shown) coupled to the support arm 116 or the base 120. The attachment mechanism may include any mechanism that couples the device mount 100 to a surface or structure. For example, the attachment mechanism may be a suction cup, an air vent mount, a cup hold mount, a clip, or the like.

The support arm 116 is coupled to the rear surface 128 of the attachment portion 112 and extends to the base 120. The base 120 supports the device mount 100 relative to a surface (e.g., a desk, table, or the like). In the illustrated implementation, the base 120 houses a power supply 136 (schematically illustrated). The power supply 136 may be a single use battery, a rechargeable battery, a 12 volt outlet, or the like. In other implementations, the power supply 136 may be housed within the support arm 116 or the attachment portion 112. The device mount 100 may further include a power switch 138 to selectively provide power to the device mount 100. In the illustrated implementation, the power switch 138 is slidably supported on base 120 and is moveable between an on position and an off position. In other implementations, the power switch 138 may have an alternative construction (e.g., push button or the like).

With continued reference to FIG. 1, the device mount 100 further includes electropermanent magnets 140a-140c and a switch 144a, 144b which are each supported within the attachment portion 112 of the housing 108. The electropermanent magnet 140a-140c is supported within the front surface 124 of the attachment portion 112. The electropermanent magnet 140a-140c emits a magnetic field that is controllable to selectively secure the device 104 to the device mount 100. The electropermanent magnet 140a-140c is operably coupled to the power supply 136 and the switch 144a, 144b.

In the illustrated implementation, the device mount 100 includes a first electropermanent magnet 140a, a second electropermanent magnet 140b, and a third electropermanent magnet 140c that are each supported within the attachment portion 112 in a triangular arrangement. In other implementations, the device mount 100 may include less (e.g., one, two) or more (e.g., four, five, etc.) electropermanent magnets 140a-140c. In addition, the electropermanent magnets 140a-140c may be arranged in any orientation to secure the device 104 to the device mount 100.

The switch 144a, 144b is operably coupled to the electropermanent magnets 140a-140c and selectively deactivates or adjusts the emitted magnetic field of the electropermanent magnets 140a-140c to release the device 104 from the device mount 100. In the illustrated implementation, the electropermanent magnets 140a-140c provide a baseline magnetic field through an embedded permanent magnet, which does not consume any energy. Activation of the switch 144a, 144b adjusts a current provided to at least one electropermanent magnet 140a-140c to regulate the emitted magnetic field. For example, when the switch 144a, 144b is activated, at least one electropermanent magnet 140a-140c is switched off (e.g., the entire magnetic field is disabled or adjusted) by having a wire coil that generates an opposing magnetic field that offsets a permanent-magnet-generated magnetic field of the electropermanent magnet 140a-140c. In some implementations, the opposing magnetic field may have the same magnitude but opposite direction as the permanent-magnet-generated magnetic field (e.g., the emitted magnetic field is zero). In some implementations, the magnitude of the opposing magnetic field may be less than the permanent-magnet-generated magnetic field such that the emitted magnetic field is still able to support the device 104. In such an implementation, the emitted magnetic field is reduced so the device 104 can be removed with a reduced force required from an operator. Since power is not required to activate the magnetic field of the electropermanent magnet(s) 140a-140c, the power supply 136 does not have to provide continuous power to the electropermanent magnet(s) 140a-140c, which increases a battery life of the device mount 100.

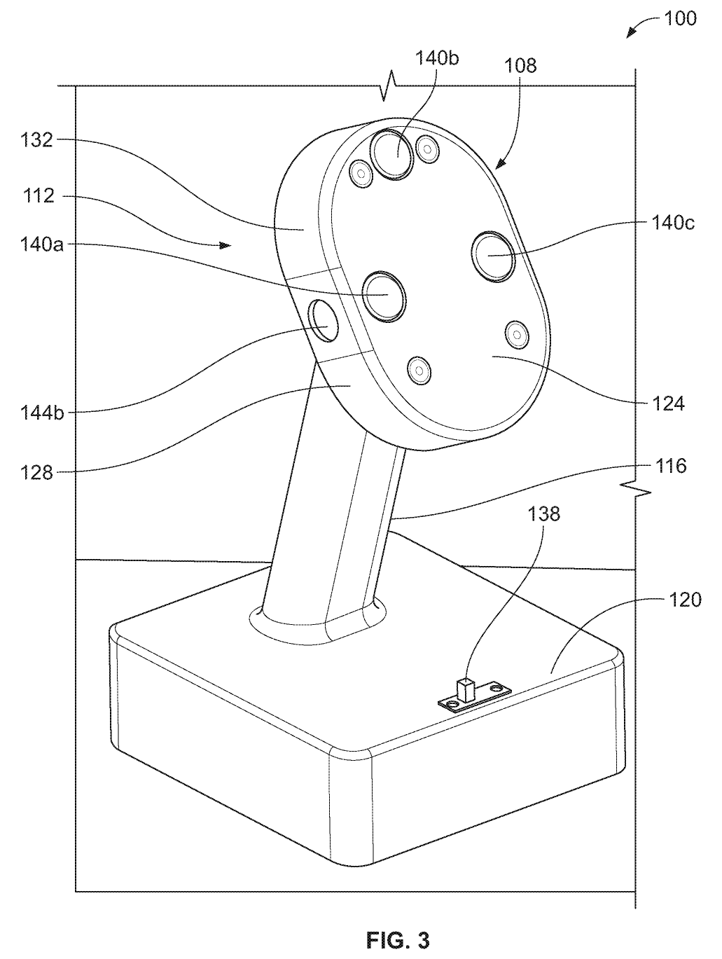

Now with reference to FIGS. 1 and 3, the device mount 100 includes a first switch 144a (FIG. 1; e.g., a right switch) and a second switch (FIG. 3; e.g., a left switch). The first switch 144a is supported within the side surface 132 of the attachment portion 112 and the second switch 144b is supported within the side surface 132 of the attachment portion 112 at a position that is opposite and spaced from the first switch. In the illustrated implementation, the first switch 144a and the second switch 144b are each touch sensors that are selectively activated when the presence of an operator’s finger is detected for a predetermined amount of time, which is described in more detail below. In other implementations, the first switch 144a and/or the second switch 144b may be an electromagnetic switch or the like. In some implementations, the device mount 100 may include a single switch. In some implementations, the first switch 144a and/or the second switch 144b may be alternatively positioned on the housing 108 (e.g., on the support arm 116, the base 120, or the like).

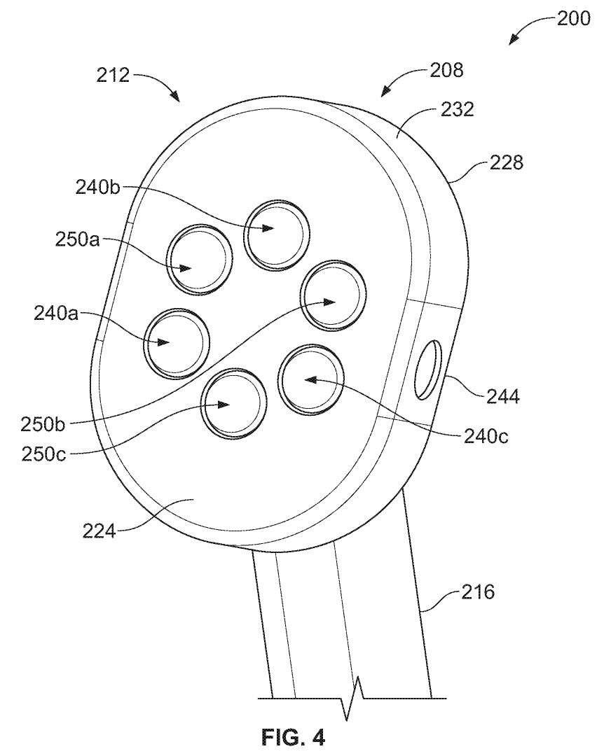

FIG. 4 illustrates a device mount 200 according to an alternative implementation. The device mount 200 is similar to the device mount 100 described above with reference to FIGS. 1-3, except as noted, and the following description focuses primarily on differences between the device mount 200 and the device mount 100. In addition, common features and elements of the device mount 200 corresponding with features and elements of the device mount 100 are given common reference numbers plus 100.

The device mount 200 includes a housing 208 defining an attachment portion 212. The attachment portion 212 includes a front surface 224, a rear surface 228, and a side surface 232 extending between the front and rear surface 224, 228. The device mount 200 includes a plurality of electropermanent magnets 240a-240c, a switch 244, and a plurality of permanent magnet 250a- 250c, which are each supported within the attachment portion 212 of the housing 208. The electropermanent magnets 240a-240c and the permanent magnets 250a-250c are supported within the front surface 224 of the attachment portion 212. The electropermanent magnets 240a-240c each emit a controllable magnetic field that is controlled by the switch 244 to selectively secure a device (e.g., shown in FIG. 2) to the device mount 200. The permanent magnets 250a-250c each emit a constant magnetic field (e.g., non-controllable) that, in conjunction with the controllable magnetic field of the electropermanent magnets 240a-240c, secures the device to the device mount 200.

In the illustrated implementation, the device mount 200 includes three electropermanent magnets 240a-240c and three permanent magnets 250a-250c positioned between respective electropermanent magnets 240a-240c in an alternating configuration. In other words, each permanent magnet 250a-250c is positioned between two of the electropermanent magnets 240a-240c. The electropermanent magnets 240a-240c and the permanent magnets 250a-250c are further arranged in a circular configuration. In other implementations, the device mount 200 may include more (e.g., four, five, etc.) or less (e.g., two, one) electropermanent magnets 240a-240c or permanent magnets 250a-250c. In addition, in other implementations, the magnets 250a-250c and 240a-240c may be arranged in a configuration having another suitable shape.

During the operation of the device mount 200, the switch 244 is operably coupled to the electropermanent magnets 240a-240c and selectively deactivates or adjusts the controllable magnetic field of the electropermanent magnets 240a-240c. Activation of the switch 244 adjusts a current provided to the electropermanent magnet 240a-240c to regulate the controllable magnetic field. For example, when the switch 244 is activated, the electropermanent magnets 240a-240c are switched off (e.g., as described above) to adjust or deactivate the controllable magnetic field of the electropermanent magnets 240a-240c. Concurrently, the constant magnetic field from permanent magnets 250a-250c is still able to support the device. In such an implementation, an overall magnetic field provided to the device (e.g., the combination of the controllable and constant magnetic field) is reduced so the device 104 can be removed with a reduced force required from an operator.

Alternatively, the electropermanent magnets 240a-240c may be replaced with electromagnets. Electropermanent magnets 240a-240c provide a magnetic field even without power or current supplied to the electropermanent magnets 240a-240c. However, electromagnets only provide a controllable magnetic field when current is supplied to the electromagnets in response to actuation of the switch 244. In such an implementation, the electromagnets may provide the controllable magnetic field to generate a pushing force to offset the holding force generated by the permanent magnets 250a-250c. In some implementations, the controllable magnetic field may partially offset the constant magnetic field from permanent magnets 250a-250c so a reduced holding force is still provided to the device 104. Therefore, the device 104 can be removed with a reduced force required from an operator. In other implementations, the controllable magnetic field may completely offset the constant magnetic field from the permanent magnets 250a-250c so the device 104 is released from the mount. In other implementations, the permanent magnets 250a-250c may be replaced with the electromagnets. In such an implementation, both the electropermanent magnets 240a-240c and the electromagnets would have controllable magnetic fields that are individually adjustable to secure and release the device 104 from the device mount 200.

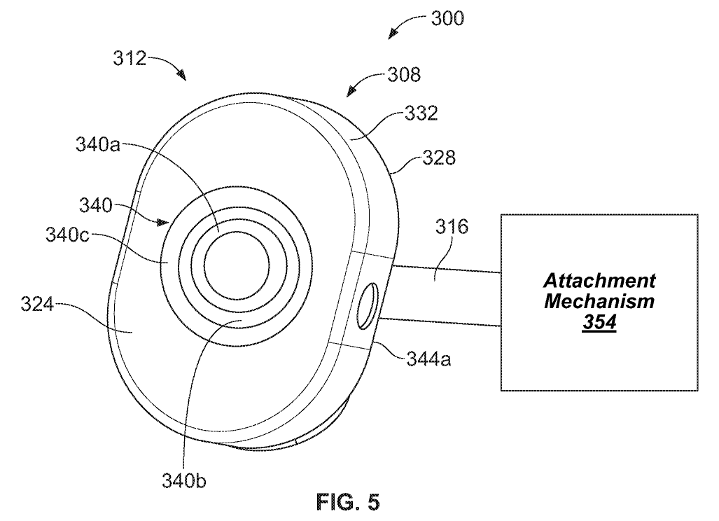

FIG. 5 illustrates a device mount 300 according to an alternative implementation. The device mount 300 is similar to the device mount 100 described above with reference to FIGS. 1-3 and the device mount 200 described above with reference to FIG. 4, except as noted, and the following description focuses primarily on differences between the device mount 300 and the device mounts 100, 200. In addition, common features and elements of the device mount 300 corresponding with features and elements of the device mount 100 are given common reference numbers plus 200.

The device mount 300 includes a housing 308 defining an attachment portion 312. The attachment portion 312 includes a front surface 324, a rear surface 328, and a side surface 332 extending between the front and rear surface 324, 328. The device mount 300 includes a magnet 340 and a switch 344a, which are each supported within the attachment portion 312 of the housing 308. In some implementations, the magnet 340 may include an array (e.g., two or more) of circular (or ring) shaped magnets 340a-340c. As shown, the array of circular shaped magnets 340a-340c are concentrically arranged. The array of circular shaped magnets 340a-340c may include any combination of permanent magnets, electropermanent magnets, and/or electromagnets. For example, the array of circular shaped magnets 340a-340c may include any number of electropermanent magnets and permanent magnets, electropermanent magnets and electromagnets, electromagnets and permanent magnets, or electropermanent magnets, electromagnets, and permanent magnets.

In other implementations, the magnet 340 is a single electropermanent magnet that has a circular (or ring shaped) geometry that matches a corresponding magnet on the device (e.g., on the Apple MagSafe^{TM} technology.

The device mount 300 further includes an attachment mechanism 354 coupled to a support arm 316. The attachment mechanism 354 may include any mechanism that couples the device mount 300 to a surface or structure. For example, the attachment mechanism may be a suction cup, an air vent mount, a cup hold mount, a clip, or the like.

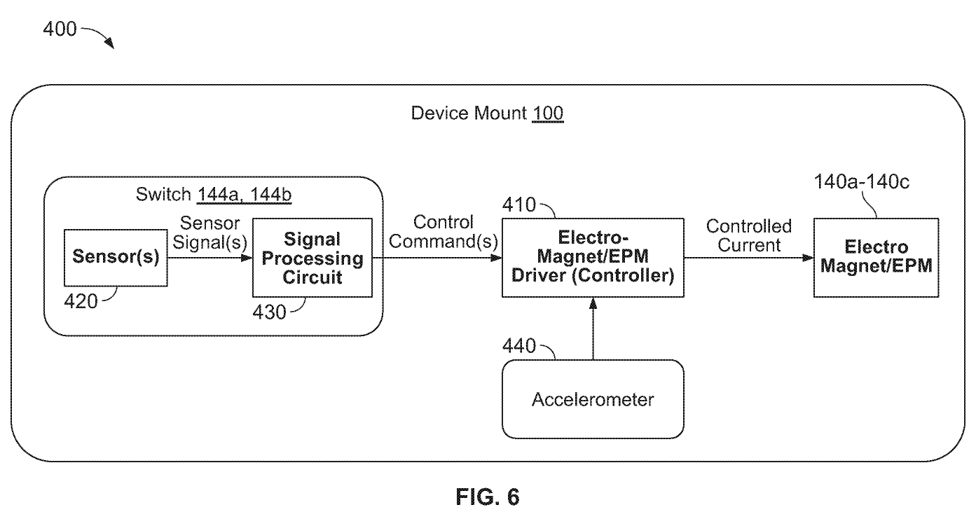

Now with reference to FIG. 6, a control system 400 of the device mount 100 is illustrated. While the control system 400 is described with respect to the device mount 100, it should be appreciated that the control system 400 may be implemented into any of the device mounts 100, 200, 300 described herein.

The control system 400 includes the switch 144a, 144b, the electropermanent magnets 140a-140c, and a controller 410 in communication with the switch 144a, 144b and the electropermanent magnet 140a-140c. The switch 144a, 144b includes a sensor(s) 420 and a signal processing circuit 430. It should be appreciated that the circuits of the control system 400 may be implemented as hardware units, such as electronic control units. As such, the circuits of the control system 400 may be implemented as one or more circuitry components including, but not limited to, processing circuitry, network interfaces, peripheral devices, input devices, output devices, sensors, etc. In some implementations, the circuits of the control system 400 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the circuits of the control system 400 may include any type of component for accomplishing or facilitating achievement of the operations described herein. However, as mentioned above, this illustration is not meant to be limiting as the present disclosure contemplates other implementations.

In the illustrated implementation, the sensor(s) 420 detects the presence of an operator’s finger and the signal processing circuit 430 sends a signal to the controller 410 corresponding to activation of the switch 144a, 144b. In response to activation of the switch 144a, 144b (e.g., a user input), the controller 410 adjusts the current provided to the electropermanent magnets 140a-140c to deactivate or adjust the magnetic field and release the device 104 from the device mount 100. In some implementations, the control system 400 may further include an accelerometer 440 in communication with the controller 410. The accelerometer 440 may detect excessive acceleration of the device mount (e.g., due to vibration or the like). The controller 410 may adjust the current to the electropermanent magnets 140a-140c to increase the emitted magnetic field when the accelerometer detects excessive acceleration on the device mount 100. It should be appreciated that the control system 400 may also be utilized with the device mounts 200, 300 when an electromagnet is incorporated therein. Similar to the electropermanent magnets 140a-140c, the controller 410 may adjust the current to the electromagnet, which adjusts the controllable magnetic field of the electromagnet.

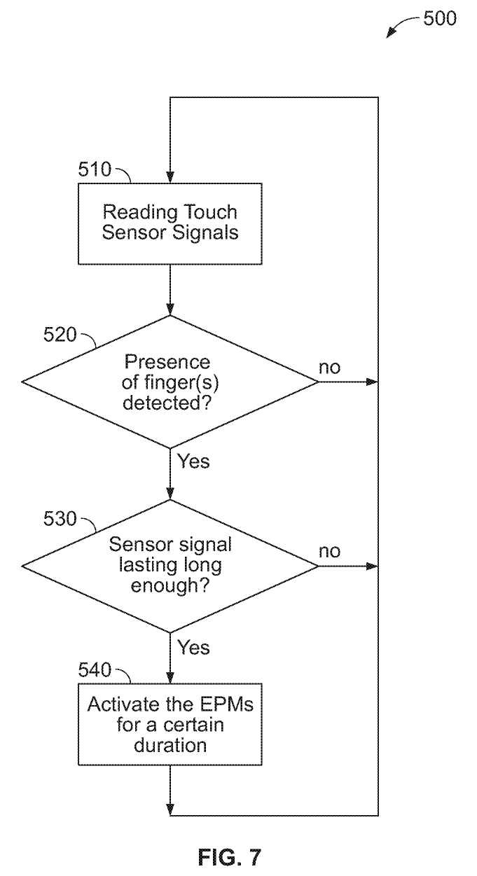

Now with reference to FIG. 7, a flow chart of a control scheme 500 for removing a device 104 from the device mount 100 is illustrated. When an operator is removing the device 104, the signal processing circuit 430 reads sensor signals (e.g., from the sensor(s) 420 (step 510). For example, signal processing circuit 430 determines whether a signal is received from the sensor(s) 420. The control system 400 determines whether the presence of a finger(s) of the operator is detected (step 520). If the presence of the finger(s) of the operator is not detected, the control scheme 500 returns to step 510. If the control system 400 determines the presence of a finger(s) of the operator is detected, the control system 400 determines if the sensor signal lasts long enough (step 530). For example, the controller 410 determines whether the signal processing circuit 430 is receiving the signal from the sensor(s) 420 for a predetermined amount of time. In other words, switch 144a, 144b is activated when the presence of an operator’s finger is detected for a predetermined amount of time. If the presence of the finger(s) of the operator is not detected for long enough, the control scheme 500 returns to step 510. If the control system 400 determines the presence of a finger(s) of the operator is detected for long enough, the controller 410 activates the electropermanent magnets 140a-140c for a certain duration of time (step 540). In other words, the current to the electropermanent magnets 140a-140c are adjusted for a predetermined duration to release the device 104 from the device mount 100.

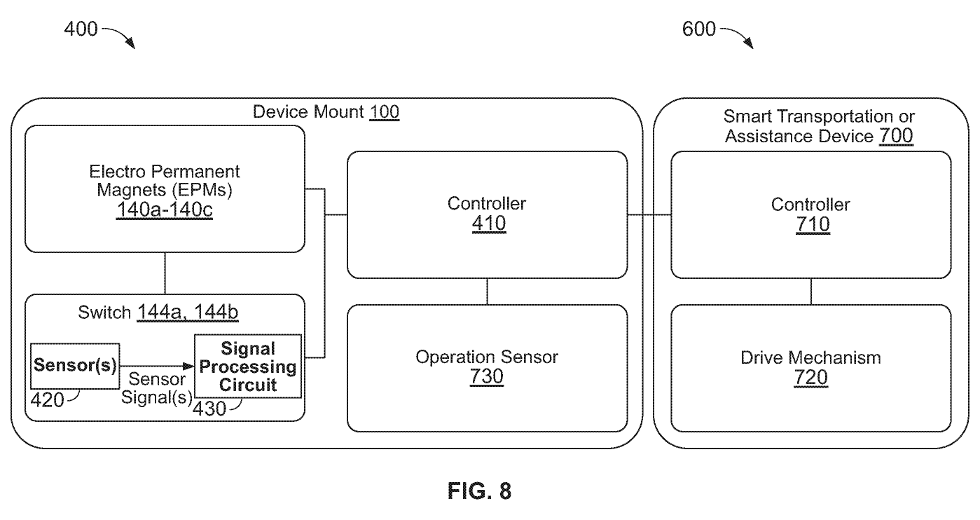

Now with reference to FIG. 8, a control system 600 between the device mount 100 and a smart transportation or assistance device 700 is illustrated. While the control system 600 is described with respect to the device mount 100, it should be appreciated that the control system 600 may be implemented into any of the device mounts 100, 200, 300 described herein.

In the illustrated implementation, the device mount 100 includes the control system 400 described above. The smart transportation or assistance device 700 may be a vehicle, airplane, a scooter, a wheelchair, a shopping cart, or the like. The smart transportation or assistance device 700 includes a controller 710 and a drive mechanism 720 (e.g., a motor, wheels, or the like). In some implementations, the controller 710 is able to determine whether the smart transportation or assistance device 700 is in operation (e.g., moving via the drive mechanism 720, moving by the operator, or the like). In other implementations, the device mount 100 may include an operation sensor 730 (e.g., a motion sensor or the like) that detects whether the smart transportation or assistance vehicle is in operation. In such an implementation, the controller 410 may not communicate with the controller 710 of the smart transportation or assistance device.

In one configuration, the circuits of the control system 600 are in the form of machine or computer-readable media that is executable by a processor (not shown) in the controller 410. For example, the machine-readable media facilitates performance of certain operations to enable reception and transmission of data. For example, the machine-readable media may provide an instruction (e.g., command, etc.) to acquire data (e.g., from the controller 710). In this regard, the machine-readable media may include programmable logic that defines the frequency of acquisition of the data (or, transmission of the data). The computer readable media may include code written in any programming language. The computer readable program code may be executed on one processor, multiple co located processors, multiple remote processors, or any combination of local and remote processors. Remote processors may be connected to each other through any type of network (e.g., CAN bus, etc.).

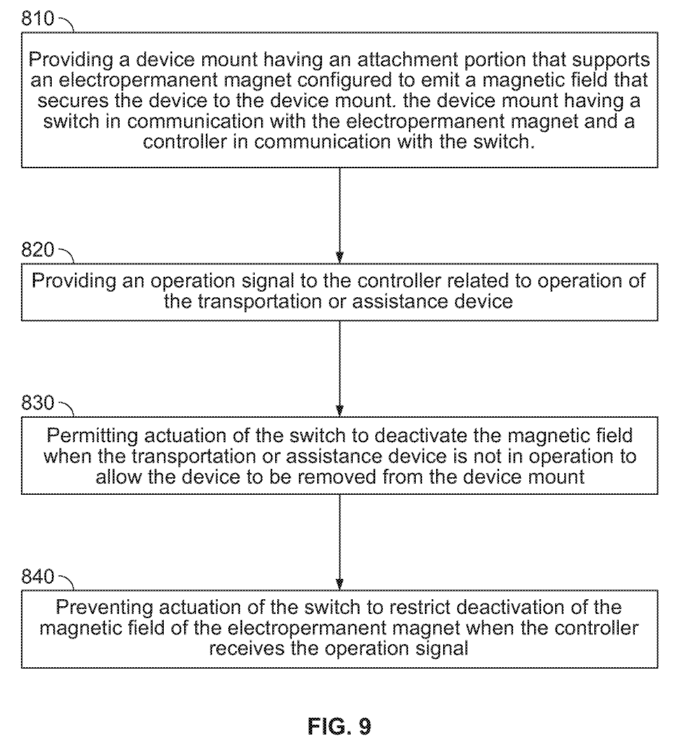

Now with reference to FIG. 9, a control scheme for the communication of the device mount 100 and the smart transportation or assistance device the smart transportation or assistance device 700 is illustrated. A device mount 100 having an attachment portion 112 that supports an electropermanent magnet 140a-140c is configured to emit a magnetic field that secures the device 104 to the device mount 100. The device mount has a switch 144a, 144b in communication with the electropermanent magnet 140a-140c and a controller 410 in communication with the switch (step 810). An operation signal is provided to the controller 410 related to operation of the transportation or assistance device 700 (step 820). In some implementations, the controller 710 provides an operation signal to the controller 410 related to the operation of the transportation or assistance device 700. In other implementations, the operation sensor 730 may provide the signal. Actuation of the switch 144a, 144b is permitted to deactivate or adjust the magnetic field when the transportation or assistance device 700 is not in operation to allow the device 104 to be removed from the device mount 100 (step 830). In some implementations, actuation of the switch 144a, 144b is permitted when the operation signal is not received by the controller 410. In other implementations, actuation of the switch is permitted when a non-operation signal is received by the controller 410 from the controller 710. Further, actuation of the switch 144a, 144b is prevented to restrict deactivation of the magnetic field of the electropermanent magnet 140a-140c when the controller 410 receives the operation signal (Step 840). In other implementations, the control scheme in FIG. 9 could be used with the device mounts 200, 300 described above.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein. It will be apparent to those skilled in the art that various modifications and variations can be made without departing from the scope or spirit. Other implementations will be apparent to those skilled in the art from consideration of the specification and practice disclosed herein. It is intended that the specification and examples be considered as exemplary only, with a true scope and spirit being indicated by the following claims.

What is claimed is:

1. A device mount configured to selectively secure a device thereto, the device mount comprising:
a housing defining an attachment portion;
an electropermanent magnet supported within the attachment portion, the electropermanent magnet configured to emit a magnetic field that secures the device to the device mount; and
a switch coupled to the housing and in communication with the electropermanent magnet, the switch configured to selectively adjust the magnetic field of the electropermanent magnet to release the device from the device mount.

2. The device mount of claim 1, further comprising a controller in communication with the switch and the electropermanent magnet, and wherein activation of the switch is configured to adjust a current provided to the electropermanent magnet to deactivate the magnetic field and release the device from the device mount.

3. The device mount of claim 2, wherein:
the switch includes a touch sensor and a signal processing circuit, and
the touch sensor is configured to be activated in response to detection of a presence of an operator’s finger.

4. The device mount of claim 3, wherein:
the touch sensor is configured to be activated when the presence of an operator’s finger is detected for a predetermined amount of time, and
the current to the electropermanent is adjusted for a predetermined duration to release the device from the device mount.

5. The device mount of claim 4, wherein:
the attachment portion includes a front surface, a rear surface opposite the front surface, and a side surface extending between the front surface and the rear surface,
the electropermanent magnet is supported within the front surface, and
the touch sensor is supported within the side surface.

6. The device mount of claim 5, wherein:
the touch sensor is a first touch sensor, and
a second touch sensor is supported within the side surface at a position that is opposite and spaced apart from the first touch sensor.

7. The device mount of claim 2, wherein the switch is an electromechanical switch.

8. The device mount of claim 2, further comprising an accelerometer in communication with the controller, and wherein the controller is configured to increase the magnetic field when the accelerometer detects excessive acceleration on the device mount.

9. The device mount of claim 1, wherein the electropermanent magnet is one of a plurality of electropermanent magnets.

10. The device mount of claim 9, further comprising a permanent magnet, and wherein the permanent magnet is positioned between two of the plurality of electropermanent magnets.

11. The device mount of claim 9, further comprising an electromagnet supported within the attachment portion, wherein the electromagnet is configured to provide a controllable magnetic field in response to actuation of the switch, and wherein the controllable magnetic field generates a pushing force to offset the magnetic field generated by the electropermanent magnets.

12. A device mount configured to selectively secure a device thereto, the device mount comprising:
a housing defining an attachment portion;
an electropermanent magnet supported within the attachment portion, the electropermanent magnet configured to emit a magnetic field that secures the device to the device mount;
a controller in communication with the electropermanent magnet, the controller configured to adjust a current provided to the electropermanent magnet to selectively adjust the magnetic field and release the device from the device mount in response to a user input.

13. The device mount of claim 12, further comprising a switch coupled to the housing and in communication with the electropermanent magnet and the controller, wherein the controller is configured to selectively adjust the magnetic field of the electropermanent magnet to release the device from the device mount in response to actuation of the switch, and wherein actuation of the switch defines the user input.

14. The device mount of claim 12, further comprising a permanent magnet, wherein the electropermanent magnet is one of a plurality of electropermanent magnets, and wherein the permanent magnet is positioned between two of the plurality of electropermanent magnets.

15. The device mount of claim 12, further comprising an accelerometer in communication with the controller, and wherein the controller is configured to increase the magnetic field when the accelerometer detects excessive acceleration on the device mount.

16. A method of coupling a device to a transportation or assistance device during operation of the transportation or assistance device, the method comprising:
providing a device mount having an attachment portion that supports an electropermanent magnet configured to emit a magnetic field that secures the device to the device mount, the device mount having a switch in communication with the electropermanent magnet and a controller in communication with the switch;
providing an operation signal to the controller related to operation of the transportation or assistance device;
permitting actuation of the switch to deactivate the magnetic field when the transportation or assistance device is not in operation to allow the device to be removed from the device mount; and
preventing actuation of the switch to restrict deactivation of the magnetic field of the electropermanent magnet when the controller receives the operation signal.

17. The method of claim 16, further comprising determining the operation signal with an operation sensor supported in the device mount.

18. The method of claim 16, further comprising determining the operation signal by receiving a signal from a control system of the transportation or assistance device.

19. The method of claim 16, wherein permitting actuation of the switch occurs when the operation signal is not received by the controller.

20. The method of claim 16, wherein permitting actuation of the switch occurs when a non-operation signal is received by the controller.
